(19) United States
(12) Patent Application Publication
(10) Pub. No.: US 2019/0261645 A1
(43) Pub. Date: Aug. 29, 2019

(54) SOFT SERVE ICE CREAM SPRAY CANISTER

(71) Applicants: James McHugh, Fleetwood, PA (US); Carol McHugh, Fleetwood, PA (US)

(72) Inventors: James McHugh, Fleetwood, PA (US); Carol McHugh, Fleetwood, PA (US)

(21) Appl. No.: 15/905,846

(22) Filed: Feb. 27, 2018

(51) Int. Cl. A23G 9/28; B65D 83/14

(52) U.S. Cl. CPC A23G 9/28; B65D 83/306; B65D 83/752

(57) ABSTRACT

A canister to store a soft serve ice cream mixture having a predetermined flavor therewithin, the canister including a body to store the soft serve ice cream mixture, and a spout disposed at a top portion of the body having an opening at a tip thereof to expel the soft serve ice cream mixture out therefrom.

### BACKGROUND

### 1. Field

The present general inventive concept relates generally to spray canister, and particularly, to a spray canister to dispense soft serve ice cream.

### 2. Description of the Related Art

Many times while out of the house, people develop cravings for sweets and ice cream, but don't have the time or patience to stop at an ice cream shop. Similarly, although one may have the urge to stop at a shop, they are not always in an area that sells ice cream.

Furthermore, if a person desires a particular type of ice cream, such as soft serve, it is often difficult to locate an ice cream shop that specializes particularly in soft serve ice cream.

Moreover, most people do not have a soft serve ice cream maker in their homes, and therefore, the only place that the average person can get soft serve ice cream is at an ice cream shop.

Finally, people who choose to purchase soft serve ice cream makers must pay thousands of dollars if they desire a soft serve ice cream maker of good quality.

Therefore, there is a need for an economic and portable device that dispenses soft serve ice cream.

### SUMMARY

The present general inventive concept provides spray canister to dispense soft serve ice cream.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a canister to store a soft serve ice cream mixture having a predetermined flavor therewithin, the canister including a body to store the soft serve ice cream mixture, and a spout disposed at a top portion of the body having an opening at a tip thereof to expel the soft serve ice cream mixture out therefrom.

The canister may further include an indicator disposed on the body to change colors in response a change in temperature around the canister.

The soft serve ice cream mixture may be mixed with a propellant gas.

The canister may further include a divider to allow another soft serve ice cream mixture having another flavor to be stored within the body without being mixed with the soft serve ice cream mixture having the predetermined flavor.

The spout may expel the soft serve ice cream mixture out the opening at the tip thereof when a top portion of the spout is pushed sideways.

The canister may be pressurized with a propellant gas to allow the soft serve ice cream mixture to be expelled out the opening at the tip of the spout in response to a top portion of the spout being pushed sideways.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a canister to dispense soft serve ice cream, according to an exemplary embodiment of the present general inventive concept;

FIG. 2A illustrates a cross sectional top view of the canister, according to an exemplary embodiment of the present general inventive concept;

FIG. 2B illustrates a cross sectional top view of a canister, according to another exemplary embodiment of the present general inventive concept;

FIG. 2C illustrates a cross sectional top view of a canister, according to another exemplary embodiment of the present general inventive concept;

FIG. 3A illustrates a top view of tip a spout, according to an exemplary embodiment of the present general inventive concept;

FIG. 3B illustrates a top view of tip a spout, according to another exemplary embodiment of the present general inventive concept;

FIG. 3C illustrates a top view of tip a spout, according to another exemplary embodiment of the present general inventive concept; and

FIG. 3D illustrates a top view of tip a spout, according to another exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

The present general inventive concept combines principles and functionality of conventional whipped cream canisters with principles and functionality of conventional soft serve ice cream dispensers. Therefore, it is important to note how conventional whipped cream canisters and conventional soft serve ice cream dispensers function in order to understand the purpose, functionality, and novelty of the present general inventive concept.

A conventional whipped cream canister (i.e., canister) contains heavy cream having about 36% butterfat (i.e., milkfat) mixed with a propellant gas, such as nitrous oxide, which are both pressurized within the canister. More specifically, within the canister, the nitrous oxide permeates the heavy cream and dissolves into the butterfat (i.e., tiny air bubbles form within the butterfat, and are known as “fat-stabilized air bubbles”). When a nozzle at the top of the canister is pressed, back pressure causes the nitrous oxide/heavy cream mixture to shoot out the canister. Once the nitrous oxide/heavy cream mixture are outside the canister, the pressure keeping the nitrous oxide dissolved within the canister is no longer present, and the nitrous oxide comes boiling out of the heavy cream, causing the heavy cream to foam. The boiling of the nitrous oxide is such that a volume of the foamed cream is four times the original volume of liquid cream, which is why nitrous-foamed cream is lighter than hand-whipped cream. In other words, if another propellant were used instead of nitrous oxide, such as oxygen, the volume of the foamed cream would be only about two times the original volume of the liquid cream. It is also important to note that if a less fatty cream were used in the conventional whipped cream canister (e.g., a cream having 15% butterfat), a thick sludge would be expelled instead of the foamy cream, because there would be less nitrous oxide dissolved due to the lower butterfat percentage. It is further important to note that freezing a conventional whipped cream canister will prevent the whipped cream from being dispensed from the canister, and may actually damage the heavy cream.

Conventional soft serve ice cream dispensers (i.e., machines) contain an ice cream mixture having about 3-11% butterfat, that is mixed with air by a centrifugal rotating blade during the freezing process, which occurs at about −4 degrees Celsius (i.e., about 24.8 degrees Fahrenheit, and as low as 19 degrees Fahrenheit). As the air is mixed into the ice cream, a volume of the ice cream increases, and overrun (i.e., an amount of air that is whipped into the mix) may be up to 60% (i.e., a volume of the ice cream increases by 60%). The ice cream/air mixture is then dispensed out of a spout, and has a fluffy texture and a temperature colder than whipped cream (which has a temperature ranging from 32 degrees Fahrenheit to 40 degrees Fahrenheit), but warmer than hard ice cream (which has a temperature ranging from 5 degrees Fahrenheit to 15 degrees Fahrenheit). It is important to note that if there is too much butterfat the soft serve ice cream, the butterfat may ball up and separate away from the molecules binding it due to the centrifugal force provided by the rotating blade, producing small pearls of butter and essentially ruining the soft serve ice cream (i.e., buttering out).

Therefore, the present general inventive concept is novel and nonobvious for at least the reason that there has not been a portable device, such as an aerosol-based canister, that effectively allows soft serve ice cream to be dispensed therefrom without jamming, freezing, expelling liquid, and/or producing pearls of butter.

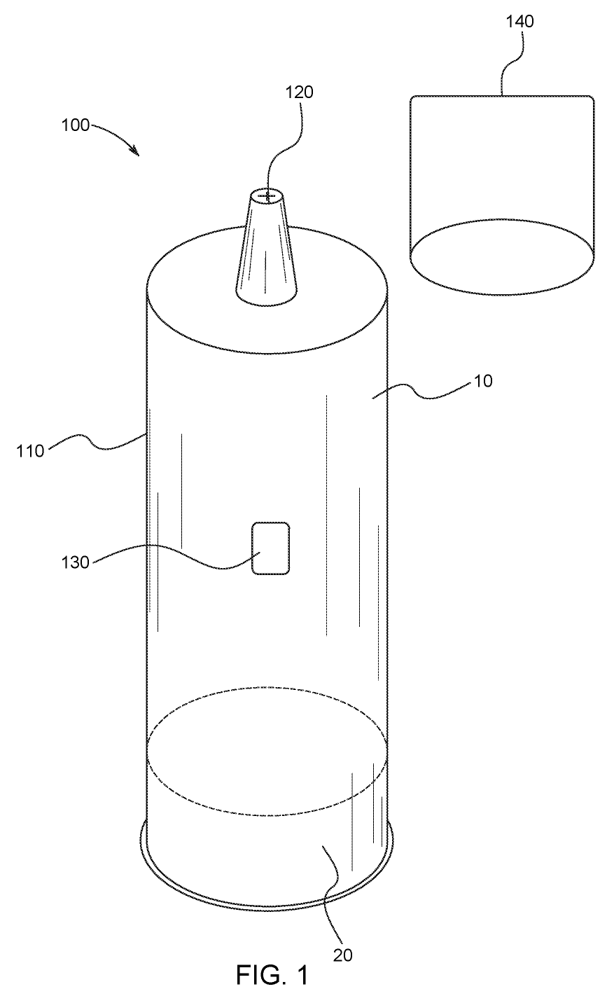

FIG. 1 illustrates a canister 100 to dispense soft serve ice cream 10, according to an exemplary embodiment of the present general inventive concept.

The canister 100 may be constructed from metal, plastic, rubber, glass, or any other material known to one of ordinary skill in the art. However, due to a pressurization of the canister 100, it may be preferable to construct the canister 100 from a metal that can withstand pressurization.

The canister 100 may include a body 110, a spout 120, an indicator 130, and a cap 140.

The body 110 may include disposed thereinside a soft serve ice cream mixture 10 and a propellant gas 20.

The soft serve ice cream mixture 10 may have any flavor, including, but not limited to, chocolate, vanilla, strawberry, peach, lime, lemon, cherry, grape, coffee, etc.

The soft serve ice cream mixture 10 may include a variety of ingredients, including, but not limited to, Milk, Sugar, Cream, Nonfat Milk Solids, Corn Syrup Solids, Mono- and Diglycerides, Guar Gum, Dextrose, Sodium Citrate, Artificial Vanilla Flavor, Sodium Phosphate, Carrageenan, Disodium Phosphate, Cellulose Gum, Vitamin A Palmitate, natural sweeteners, artificial sweeteners, etc.

The propellant gas 20 may be nitrous oxide, carbon dioxide, oxygen, or any other aerosol compatible gas known to one of ordinary skill in the art.

FIG. 1 depicts the soft serve ice cream mixture 10 disposed above the propellant gas 20, but in actuality, the propellant gas 20 is most likely mixed with the soft serve ice cream mixture 10. Alternatively, a barrier (not illustrated) may be disposed between the soft serve ice cream mixture 10 and the propellant gas 20, and the barrier may actually push the soft serve ice cream mixture 10 out of the spout 120.

The spout 120 may be disposed at a top portion of the body 110, and may be a spout that functions similarly to a conventional whipped cream canister spout. As such, when the canister 100 is held is the spout 120 facing downward, pressing the spout 120 to a side may cause the soft serve ice cream mixture 10 to be propelled out a tip (i.e., opening, aperture, etc.) 121 of the spout 120. More specifically, pressing the spout 120 to the side may cause a mechanism within the spout 120 to release the propellant gas 20 out of the spout 120 along with the ice cream mixture 10. In other words, as the spout 120 is pressed to the side, the propellant gas 20 (along with the mixture 10), will naturally escape out of the spout 120 because of the built up pressure of the propellant gas 20 within the canister 100. As such, the spout 120 expels the soft serve ice cream mixture 10 out the opening at the tip 121 when a top portion of the spout is pushed sideways.

For example, the spout 120 may include springs, ball bearings, levers, walls, doors, actuators, valves, etc., but is not limited thereto.

The indicator 130 may be disposed on the body 110, and may be a temperature indicator that changes color and/or displays a number indicating a temperature of the canister 100. In other words, the indicator 130 may be made from a temperature-sensitive material that changes color when placed in an environment having a particular temperature (similar to a mood ring). As such, the canister 100 may be stored in a refrigerator at a temperature between 32 degrees and 40 degrees, but the soft serve ice cream mixture 10 within the canister 100 may not be sufficiently hardened. When the canister 100 is stored within the refrigerator, the indicator 130 may remain a black color. However, canister 100 may be placed into a freezer for a predetermined time period (e.g., 5 to 10 minutes), until the soft serve ice cream mixture 10 reaches approximately 19 degrees, and in effect sufficiently freezes to a consistency of conventional soft serve ice cream. The indicator 130 may change to a different color, such as green, blue, red, etc., in order to indicate that the soft serve ice cream mixture 10 is at a proper temperature to have the consistency of conventional soft serve ice cream. Alternatively, the soft serve ice cream mix 10 may have special ingredients that cause the soft serve ice cream mix 10 to be hardened to the consistency of conventional soft serve ice cream even if stored in a refrigerator at a temperature between 32 degrees and 40 degrees.

The cap 140 may cover a top portion of the body 110, such that the spout 120 is covered and protected from outside contaminants.

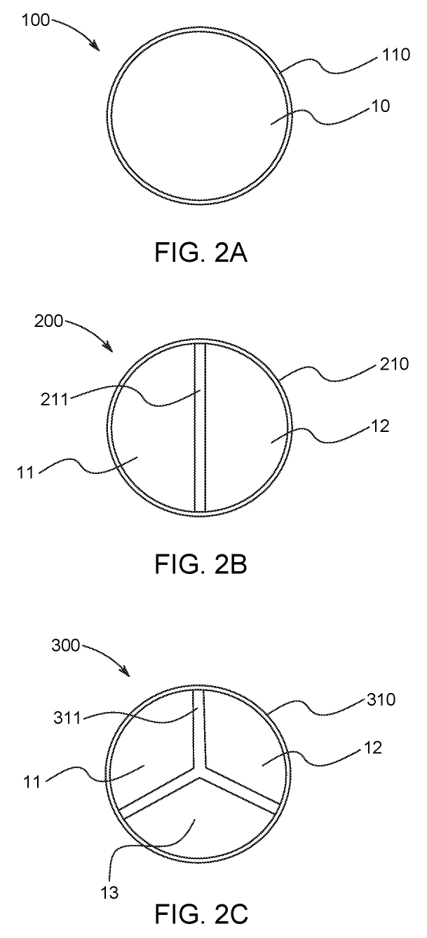

FIG. 2A illustrates a cross sectional top view of the canister 100, according to an exemplary embodiment of the present general inventive concept.

Referring to FIG. 2A, the canister 100 includes one flavor of the soft serve ice cream mixture 10.

FIG. 2B illustrates a cross sectional top view of a canister 200, according to another exemplary embodiment of the present general inventive concept.

Referring to FIG. 2B, a canister 200 includes two different flavors of a first soft serve ice cream mixture 11 and a second soft serve ice cream mixture 12. The first soft serve ice cream mixtures 11 and the second soft serve ice cream mixture 12 may be divided by a divider 211 disposed within the body 210, which may extend from a top of the canister 200 to a base of the canister 200. Also, the divider 211 may extend across an entire diameter of the canister 200, as illustrated in FIG. 2B.

FIG. 2C illustrates a cross sectional top view of a canister 300, according to another exemplary embodiment of the present general inventive concept.

Referring to FIG. 2C, a canister 300 includes three flavors of a first soft serve ice cream mixture 11, a second soft serve ice cream mixture 12, and a third soft serve ice cream mixture 13. The first soft serve ice cream mixture 11, the second soft serve ice cream mixture 12, and the third soft serve ice cream mixture 13 may be divided by a divider 311 disposed within the body 310, which may extend from a top of the canister 300 to a base of the canister 300. Also, the divider 311 may extend across an entire diameter of the canister 300 in three separate sections, as illustrated in FIG. 2C.

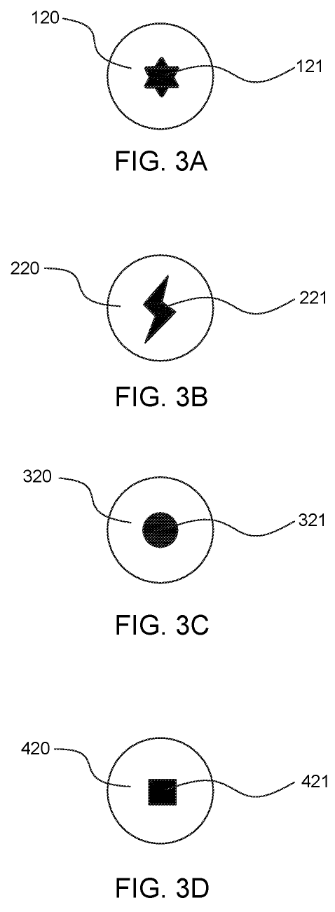

FIG. 3A illustrates a top view of tip 121 a spout 120, according to an exemplary embodiment of the present general inventive concept.

The tip 121 may have a star-like shape.

FIG. 3B illustrates a top view of tip 221 a spout 220, according to another exemplary embodiment of the present general inventive concept.

The tip 221 may have a lightning bolt-like shape.

FIG. 3C illustrates a top view of tip 321 a spout 320, according to another exemplary embodiment of the present general inventive concept.

The tip 321 may have a circular shape.

FIG. 3D illustrates a top view of tip 421 a spout 420, according to another exemplary embodiment of the present general inventive concept.

The tip 421 may have a square shape.

Referring to FIGS. 3A through 3D, the spout 120, the spout 320, the spout 320, and the spout 420 may be fixed parts of the canister 100, or may be detachable and attachable to the canister 100 in order to allow a user to utilize the different tip shapes to decorate ice cream cakes, for example.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A canister to store a soft serve ice cream mixture having a predetermined flavor therewithin, the canister comprising:
a body to store the soft serve ice cream mixture;
a spout disposed at a top portion of the body having an opening at a tip thereof to expel the soft serve ice cream mixture out therefrom; and
a divider extending across a diameter of an inner portion of the body to allow another soft serve ice cream mixture having another flavor to be stored within the body without being mixed with the soft serve ice cream mixture having the predetermined flavor while within the body, such that both the soft serve ice cream mixture and the another soft serve ice cream mixture are simultaneously dispelled from the spout in response to a manipulation of the spout.

2. The canister of claim 1, further comprising:
an indicator disposed on the body to change colors in response a change in temperature around the canister.

3. The canister of claim 1, wherein the soft serve ice cream mixture is mixed with a propellant gas.

4. (canceled)

5. The canister of claim 1, wherein the spout expels the soft serve ice cream mixture out the opening at the tip thereof when a top portion of the spout is pushed sideways.

6. The canister of claim 1, wherein the canister is pressurized with a propellant gas to allow the soft serve ice cream mixture to be expelled out the opening at the tip of the spout in response to a top portion of the spout being pushed sideways.
